(19) United States
(12) Patent Application Publication
(10) Pub. No.: US 2007/0079283 A1
(43) Pub. Date: Apr. 5, 2007

(54) Program generation method and program product

(76) Inventors: Shigeta Kuninobu, Kawasaki-Shi (JP); Hiromasa Shin, Yokohama-Shi (JP)

Correspondence Address: NIXON & VANDERHYE, PC, 901 NORTH GLEBE ROAD, 11TH FLOOR, ARLINGTON, VA, 22203, US

(21) Appl. No.: 11/514,224

(22) Filed: Sep. 1, 2006

(30) Foreign Application Priority Data
Sep. 1, 2005 (JP) 2005-253463

(51) Int. Cl. G06F 9/44; G06F 12/14

(52) U.S. Cl. 717/106; 711/163

(57) ABSTRACT

There is provided with a program generation method, including: inputting a source program; inputting a memory protection policy in which functions included in the source program are classified into either of a plurality of domains each assigned an access control table; generating information which represents a relation between each global variable in the source program and domains utilizing the each global variable; every global variable, dividing domains utilizing the global variable into one or more high-order domains and one or more low-order domains, every global variable; every global variable, adding to the source program an instruction which sets access restriction on the global variable to reading and writing permission in access control tables of the high-order domains; and every global variable, adding to the source program an instruction which sets access restriction on the global variable to reading permission in access control tables of the low-order domains.

### CROSS-REFERENCE TO RELATED APPLICATIONS

This application is based upon and claims the benefit of priority from the prior Japanese Patent Applications No. 2005-253463 filed on Sep. 1, 2005, the entire contents of which are incorporated herein by reference.

### BACKGROUND OF THE INVENTION

1. Field of the Invention

The present invention relates to a program generation method and a program product.

2. Related Art

In an environment in which a plurality of program components are executed on a single memory address space, there is a possibility that inclusion of a bug or a malicious program component will destroy a memory area utilized by other components and shut down the whole system. Therefore, there is a technique of providing a boundary between components on the single memory address space and preventing a bug or a malicious program component, if any, from affecting other components.

A memory protection unit between a CPU and a memory performs memory protection by managing access from the CPU to the memory based on an access control table which indicates memory areas with access restrictions and kinds of the access restrictions (such as Execute (EX), Read-Write (RW), Read-Only (RO) and Access-Inhibit (NO)) (JP-A 5-289944(KOKAI)). In order to use above mentioned memory protection unit, the software developer must write program codes premised on use of a memory protection unit. For example, software developer must consider the usage of memory areas (a text area, a data area, a heap area and a stack area). It imposes a heavy burden on the software developer. In addition, there is a risk that the reliability of the program will be lowered by manually adding the memory protection function which is not a main function. Furthermore, the memory protection function cannot be utilized when using a program developed by another person.

### SUMMARY OF THE INVENTION

According to an aspect of the present invention, there is a program generation method for generating a program to be executed in a system in which access from a CPU to a memory device is controlled based on an access control table describing access restriction for the memory device, comprising: inputting a source program; inputting a memory protection policy in which functions included in the source program are classified into either of a plurality of domains respectively, the access control table being assigned to each of the domains; generating information which represents a relation between each global variable in the source program and domains utilizing the each global variable; dividing domains utilizing the global variable into one or more high-order domains and one or more low-order domains; adding to the source program an instruction which sets access restriction on the global variable to reading and writing permission in access control tables of the high-order domains; and adding to the source program an instruction which sets access restriction on the global variable to reading permission in access control tables of the low-order domains. According to an aspect of the present invention, there is provided with a program product for generating a program to be executed in a system in which access from a CPU to a memory device is controlled based on an access control table describing access restriction for the memory device, comprising modules for: inputting a source program; inputting a memory protection policy in which functions included in the source program are classified either of a plurality of domains respectively, the access control table being assigned to each of the domains; generating information which represents a relation between each global variable in the source program and domains utilizing the each global variable; dividing domains utilizing the global variable into one or more high-order domains and one or more low-order domains; adding to the source program an instruction which sets access restriction on the global variable to reading and writing permission in access control tables of the high-order domains; and adding to the source program an instruction which sets access restriction on the global variable to reading permission in access control tables of the low-order domains.

### BRIEF DESCRIPTION OF THE DRAWINGS

FIG. 1 shows an execution environment of a program having a memory protection function generated according to an embodiment;

FIG. 2 shows a configuration of a program generation apparatus according to an embodiment of the present invention;

FIG. 3 is a functional block diagram of weaver 1;

FIG. 4 is a flow chart showing processing conducted by weaver 1 in detail;

FIG. 5 is a diagram showing an example of an access control table;

FIG. 6 is a diagram showing an example of a memory protection policy;

FIGS. 7A to 7D show examples of function-domain correspondence information, domain hierarchical information, argument information, and global variable-utilization domain information;

FIG. 8 is a flow chart showing a procedure of adding an instruction which registers access restriction concerning an area utilized by a global variable into an access control table;

FIG. 9 is a diagram showing processing conducted by a compiler & linker 3 and weaver 2 in FIG. 2;

FIG. 10 is a diagram showing an example of a terminal address table;

FIG. 11 is a diagram showing an example of a source program;

FIG. 12 is a diagram showing a program generated from a source program shown in FIG. 11 and a memory protection policy shown in FIG. 6; and

FIG. 13 is a diagram showing a source program having a memory protection function generated from a program shown in FIG. 12 and a terminal address table shown in FIG. 10.

### DETAILED DESCRIPTION OF THE INVENTION

In an embodiment, a memory protection policy obtained by classifying functions in a program into domains and the program are input, and it is attempted to automatically generate a program capable of utilizing a memory protection unit while preventing a trouble such as a bug from propagating beyond a domain boundary. Hereafter, the present embodiment will be described with reference to the drawings.

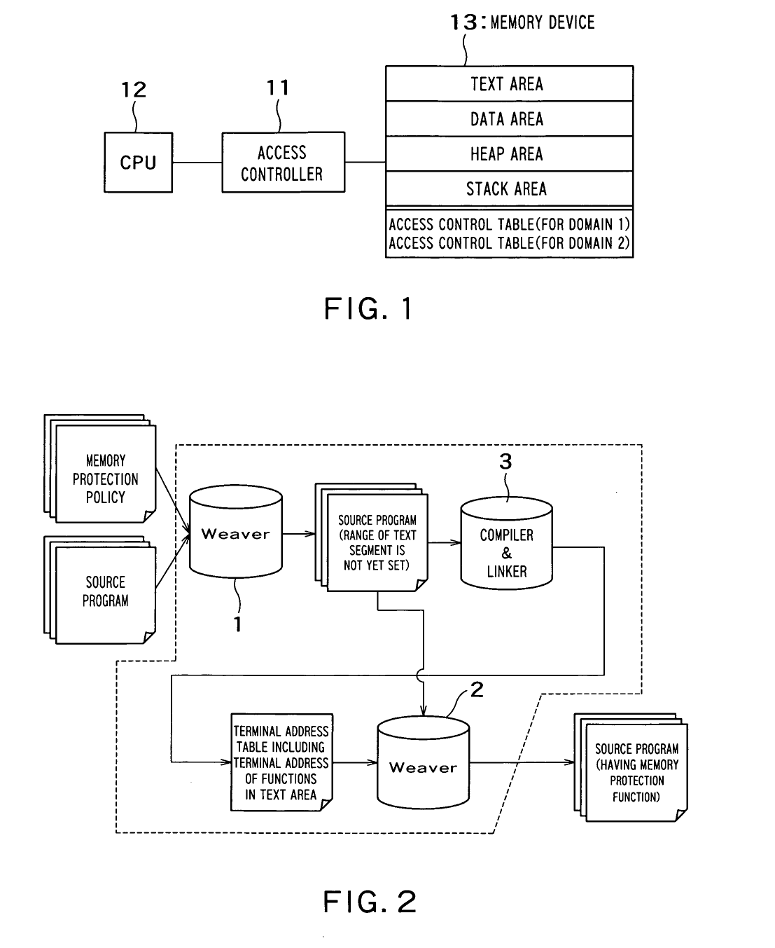

FIG. 1 is a system configuration diagram showing an execution environment of a program having a memory protection function generated by the present embodiment.

This system includes a CPU 12, a memory device 13, and an access controller 11. The memory device 13 stores a program having a memory protection function generated by the present embodiment. The CPU 12 executes the program having the memory protection function. The memory protection unit (access controller) 11 is located between the CPU 12 and the memory device 13. The memory protection unit 11 monitors access from the CPU 12 to the memory device 13 by referring to access control tables in the memory device 13. An access control table is present for each domain. The access control table is operated by a function (instruction) which operates the access control table from a program having a memory protection function generated according to the present embodiment. An access control table of a domain to be referred to by the access controller is also specified by the generated program having the memory protection function. If access from the CPU 12 is allowed by the corresponding access control table, the access controller 11 passes the access to the memory device 13. If access from the CPU 12 is not allowed, the access controller 11 functions to intercept the access.

FIG. 2 is a block diagram showing a configuration of a program generator implementing a program generation method according to an embodiment of the present invention is executed. This program generator has a function of generating a source program having a memory protection function on the basis of a memory protection policy and a source program, input from outside. The program having the memory protection function described with reference to FIG. 1 is obtained by conducting compile and link processing on the source program having the memory protection function generated by the program generator shown in FIG. 2 to make it executable.

The program generator in FIG. 2 uses broadly two devices, i.e., weaver 1 and weaver 2 to weaver a code concerning memory protection into the input source program. The weaver 1 and weaver 2 represent hardware modules when these functions are implemented by using hardware. The weaver 1 and weaver 2 represent program modules when these functions are implemented by using programs. The set of the program modules corresponds to a program product.

The weaver 1 weaves access control table operation instructions concerning a data area, a stack area and a heap area into a source program. As regards an access control table operation instruction concerning a text area, the weaver 1 weaves it into the program with a memory address range unset.

A compiler & linker 3 generates a terminal address table which describes terminal addresses of functions in the text area on the basis of the source program passed through the weaver 1.

The weaver 2 fixes memory address ranges of functions which have not yet been set in the weaver 1, by utilizing the terminal address table output by the compiler & linker 3, and writes the fixed memory address ranges into the source program passed through the weaver 1.

A program having a memory protection function which can be executed by the CPU 12 is obtained by conducting ordinary compile processing and link processing on the source program passed through the weaver 2 (a source program having memory protection).

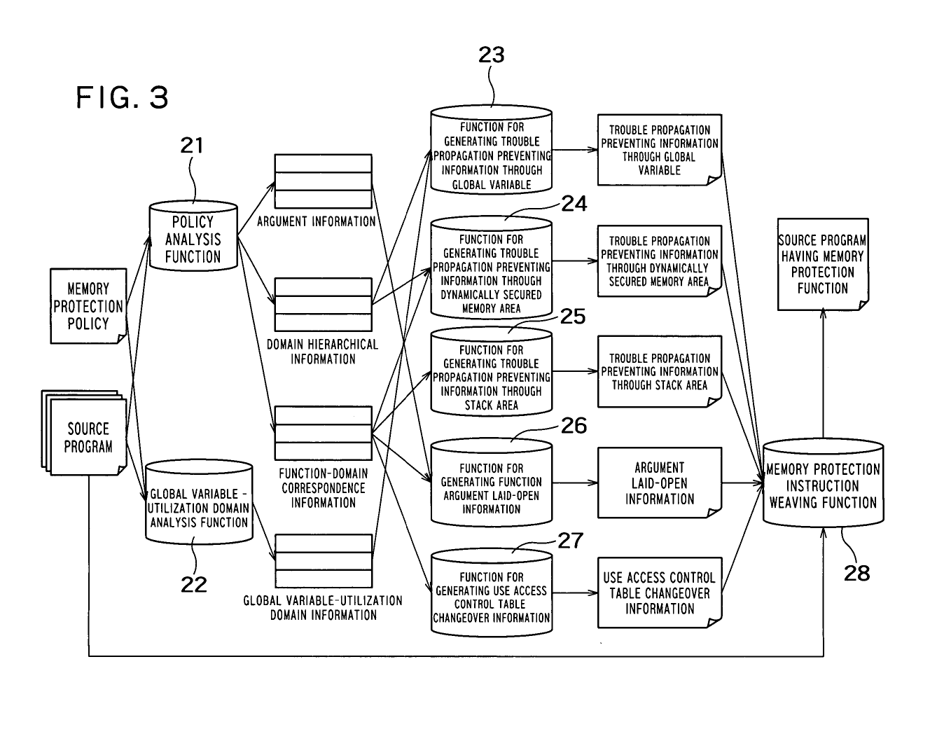

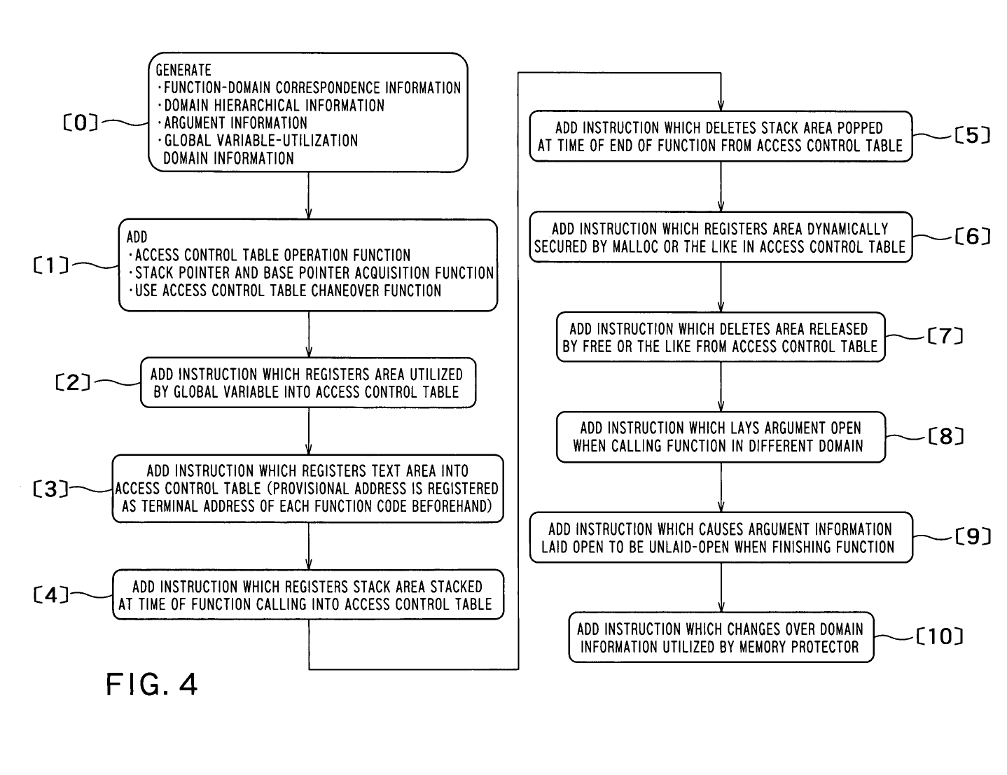

FIG. 3 is a functional block diagram of the weaver 1. FIG. 4 is a flow chart showing processing conducted by the weaver 1 in detail.

The weaver 1 writes additionally a memory protection instruction to a suitable place in the original source program in steps [1] to [10] shown in FIG. 4. The order of the steps [1] to [10] in the flow chart shown in FIG. 4 is an example. The order of them may be arbitrary. As for the initial states in the access control tables respectively for the domains, all areas (the stack area, the heap area, the data area and the text area) are set to NO (Access-Inhibit).

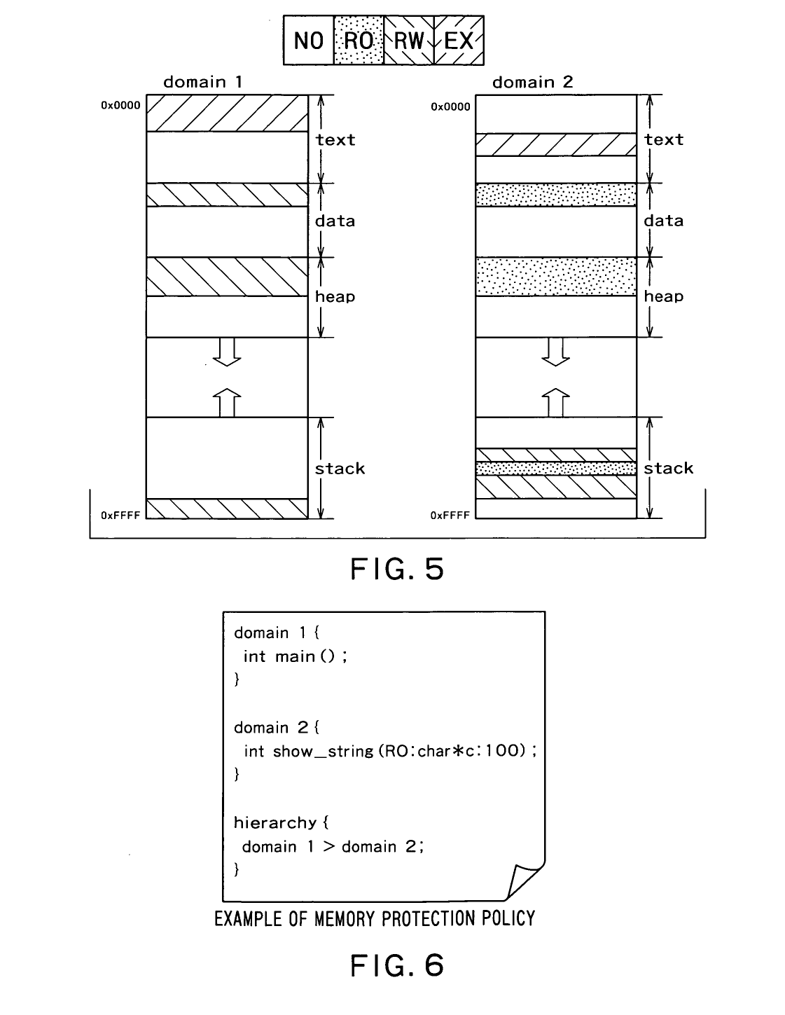

FIG. 5 shows examples of the access control tables.

Access control tables for two domains (domain 1 and domain 2) are shown. The access control tables manage access restrictions of memory addresses in the memory area. As for access restrictions, there are Execute (EX), Read-Write (RW), Read-Only (RO) and Access-Inhibit (NO). In each memory address, one of the access restrictions is set. In the initial state, “NO” is set in all memory addresses in the access control tables of both the domain 1 and the domain 2.

Hereafter, the weaver 1 will be described in detail with reference to FIG. 3 and FIG. 4.

Step [0]:

The weaver 1 generates “function-domain correspondence information,” “domain hierarchical information,” and “argument information” from the memory protection policy by using a policy analysis function 21. Furthermore, the weaver 1 generates “global variable-utilization domain information” from the source program and the memory protection policy by using a global variable-utilization domain analysis function 22.

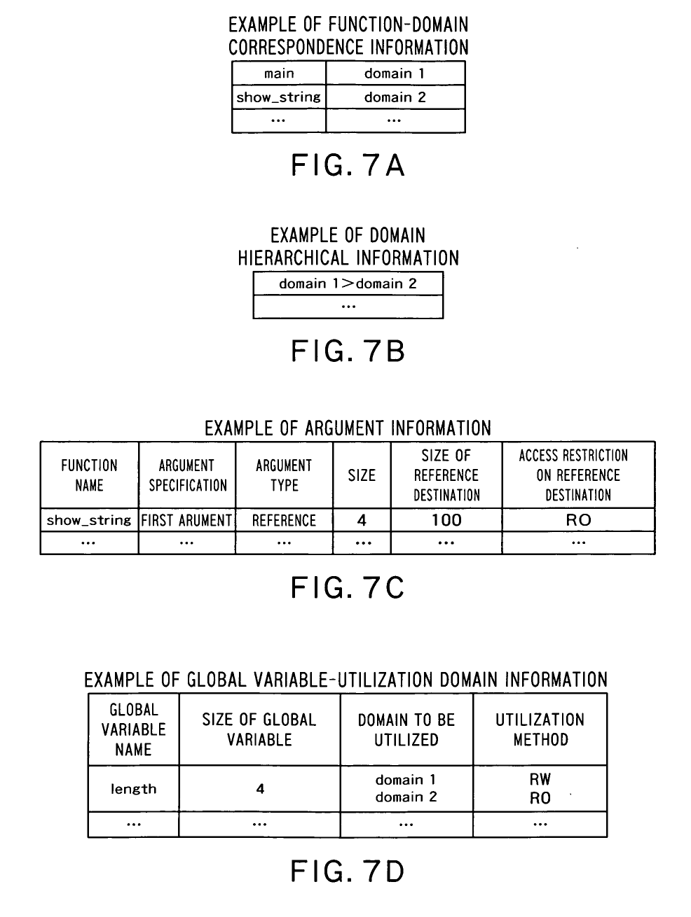

FIG. 6 shows an example of the memory protection policy. FIG. 7A is a diagram showing an example of function-domain correspondence information. FIG. 7B is a diagram showing an example of domain hierarchical information. FIG. 7C is a diagram showing an example of argument information. FIG. 7D is a diagram showing an example of global variable-utilization domain information.

In the memory protection policy shown in FIG. 6, functions in the source program are classified into domains every function. The memory protection policy is generated by a programmer or the like beforehand. In the example shown in FIG. 6, two domains, i.e., a domain 1 and a domain 2 are defined. A function “main” belongs to the domain 1, and a function “show_string” belongs to the domain 2. The function “show_string” includes a pointer argument c which indicates a char type. In an address control table corresponding to a domain 2 to which the function “show_string” belongs, it is shown to set an area (data area) having a size of 100 (for example, 100 bytes) beginning with an address indicated by the pointer c to the RO (Read-Only). “hierarchy” determines hierarchical relations between domains. In the present example, the domain 1 is higher in order than the domain 2.

In FIG. 7A, the function-domain correspondence information associates functions with domains to which the functions belong, respectively.

In FIG. 7B, domain hierarchical information represents hierarchical relations between domains.

In FIG. 7C, argument information represents information of arguments contained in functions used in a program. “ARGUMENT SPECIFICATION” identifies an argument used in each function. If a plurality of arguments are used in a function, then an argument located in a first place (for example, an argument described on the leftmost side in parentheses of the function) is identified as a first argument and an argument located in a second place is identified as a second argument. Since “show_string” has only one argument, only the first argument is described. “ARGUMENT TYPE” indicates whether the argument is reference type or a value. If the argument is a pointer, the “ARGUMENT TYPE” becomes “reference.” If the argument is a numerical value, the “ARGUMENT TYPE” becomes “value.” “SIZE” indicates the size of the argument (4 bytes in the present example). “SIZE OF REFERENCE DESTINATION” indicates how many bytes should be handled from an address specified by a pointer. “ACCESS RESTRICTION ON REFERENCE DESTINATION” represents access restriction on an area indicated by the “SIZE OF REFERENCE DESTINATION.”

In FIG. 7D, global variable-utilization domain information represents information of respective global variables used in the program. Respective global variables are detected by scanning the source program. “DOMAIN TO BE UTILIZED” is a domain(s) to which a function(s) using a global variable belongs. All functions to which a global variable belongs are detected. Domains to which the detected functions belong are detected from the memory protection policy or the function-domain correspondence information.

Step [1]:

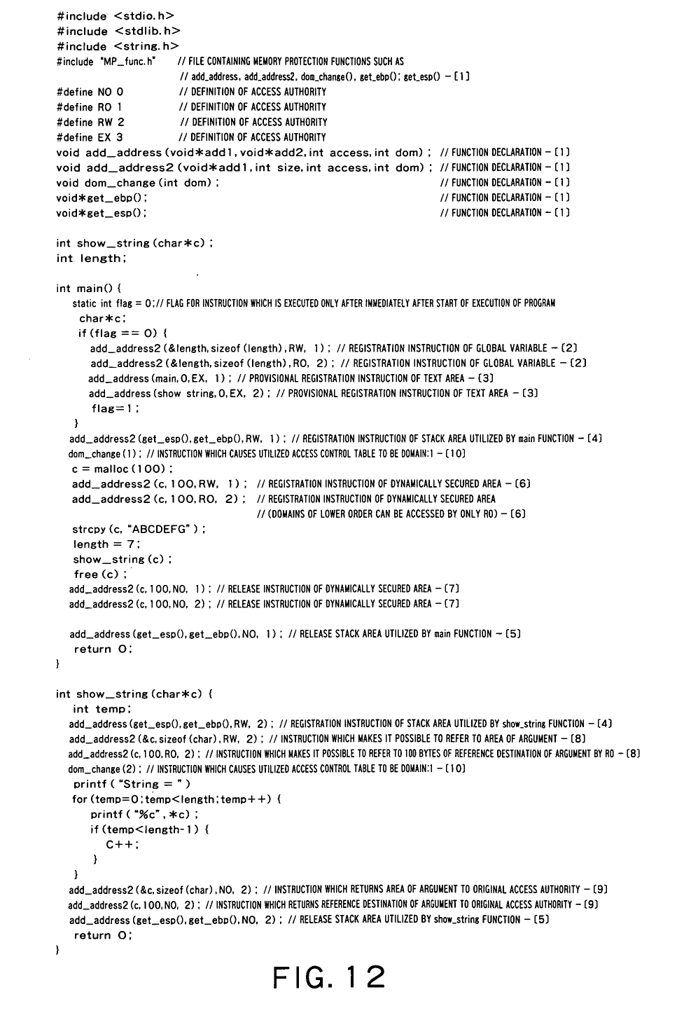

The weaver 1 addes an access control table operation function, a stack pointer acquisition function, a base pointer acquisition function and an access control table changeover function into the source program as new functions (see [1] in FIG. 12 described later).

The access control table operation function is a function which registers specified access restriction for a specified memory address range in an access control table by specifying a domain, a memory address range, and access restriction, the access control table being associated with the domain specified.

In the ensuing description, a function which registers a range of addresses st to ed with access restriction a∈{RO, RW, EX, NO} in an access control table of a domain d (d∈D) contained in a domain set D is expressed as

add_address(st, ed, a, {d}).

A function which registers a range having a size of s bytes from the address st with the access restriction “a” in the access control table of the domain d contained in the domain set D is expressed as

add_address(st, s, a, {d}).

The stack pointer acquisition function is a function which acquires an address of a stack pointer in a function which is being executed.

In the ensuing description, the stack pointer acquisition function is expressed as

get_esp( ).

The base pointer acquisition function is a function which acquires an address of a base pointer in a function which is being executed.

In the ensuing description, the base pointer acquisition function is expressed as

get_ebp( ).

The access control table changeover function is a function which changes over an access control table referred to by the access controller 11 to an access control table for a specified domain d.

In the ensuing description, this function is expressed as

dom_change(d).

Step [2]:

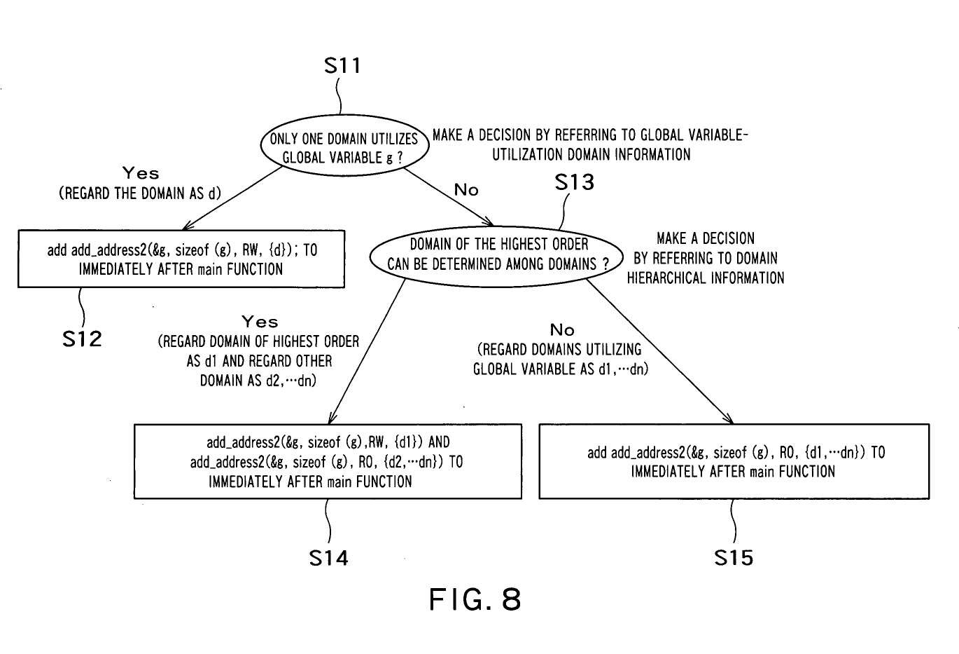

An instruction which registers access restriction with respect to an area utilized by a global variable into an access control table is added according to a procedure of a flow chart shown in FIG. 8, in a manner in which the instruction is executed only once immediately after start of a program (immediately after start of a main function). An instruction is added for every global variable appearing in the global variable-utilization domain information, according to the procedure shown in FIG. 8. Hereafter, further details will be described.

A Function 23A for generating trouble propagation preventing information through global variable in the weaver 1 determines whether one domain utilizes the target global variable (which is supposed to be g) on the basis of the global variable-utilization domain information (S11).

If it is found that only one domain utilizes the global variable g (YES at S11), then add_address2(&g, sizeof(g), RW, {d}); is generated for the domain (which is supposed to be d). And this instruction and a position on the source program (immediately after the start of the main function) in which the instruction should be inserted are delivered to a memory protection instruction weaving function 28 as trouble propagation preventing information through global variable. The memory protection instruction weaving function 28 inserts the instruction into the source program on the basis of this trouble propagation preventing information (S12) (see [2] in FIG. 12).

If it is found at S11 that a plurality of domains utilize the global variable g (NO at S11), then it is determined on the basis of domain hierarchical information whether a domain of the highest order can be determined among the plurality of domains (S13). If a domain of the highest order can be determined (YES at S13), then add_address2(&g, sizeof(g), RW, {d1}); is generated for the domain d1 of the highest order and add_address2(&g, sizeof(g), RO, {d2, . . . dn}); is generated for other domains d2, . . . dn. And these instructions and positions on the source program (immediately after the start of the main function) in which the instructions should be inserted are delivered to the memory protection instruction weaving function 28 as trouble propagation preventing information through global variable. The memory protection instruction weaving function 28 inserts these instructions into the source program on the basis of this trouble propagation preventing information (S14).

If the domain of the highest order cannot be determined (NO at S13), then add_address2(&g, sizeof(g), RO, {d1, . . . dn}); is generated, where d1, . . . dn are domains utilizing the global variable g. And this instruction and a position on the source program (immediately after the start of the main function) in which the instruction should be inserted are delivered to the memory protection instruction weaving function 28 as trouble propagation preventing information through global variable. The memory protection instruction weaving function 28 inserts the instruction into the source program on the basis of this trouble propagation preventing information.

In the procedure heretofore described, it is also possible to cause access control for each domain to be included in global variable-utilization domain information as the “utilization method” when generating the global variable-utilization domain information and generate trouble propagation by way of global variable preventing information by using the global variable-utilization domain information including the utilization method. In this case, the procedure (S11 and S13) for making a decision as to the hierarchical relation between domains can be omitted in the procedure shown in FIG. 8.

If there are a plurality of domains of the highest order, then it is possible to set a=RW for all domain. If it is found by a program analysis that all functions belonging to a domain of the highest order do not read values from the global variable g (for example, in the case of only writing) even in the case where there is only the single domain of the highest order, then it is possible to set a=RW for the domain of the highest order and handle a domain of a second order as a domain of the highest order (a=RW can be set for the domain of the second order as well)

Step [3]:

The weaver 1 adds instructions which register access restriction on areas where program instructions of respective functions are stored, in access control tables to the source program with respect to all functions in the source program.

The following instruction is added in a manner in which it is executed only once immediately after start of the program (see [3] in FIG. 12). Here, d is a domain to which a function f belongs, and it can be known from function-domain correspondence information.

add_address(f, 0, EX, {d});

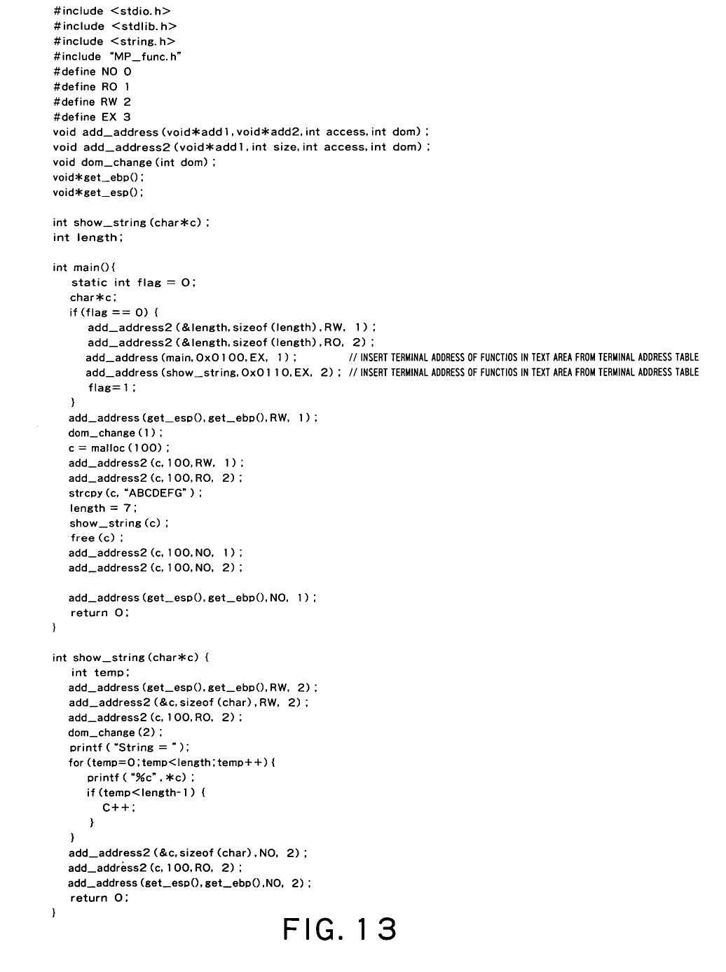

It is supposed that the terminal address of the area is provisionally 0 (provisional address). This is because the terminal address is not yet determined before the source program is passed through the compiler & linker 3. Thereafter, in the weaver 2, the provisional address is rewritten to be replaced by a correct terminal address on the basis of the terminal address table obtained from the compiler & link 3 (see FIG. 13 described later). By the way, f is a start address of the function f. When conducting compile and link processing on the program generated by the program generator shown in FIG. 2, this start address is inserted in the position of f.

Step [4]:

When the function f is called, an instruction which registers access restriction on a stack area utilized by the function f is added to the source program. Hereafter, further details will be described.

A function 25 for generating trouble propagation preventing information through stack area in the weaver 1 generates the following instruction to be inserted immediately after start of each function with respect to all functions in the program. Here, d is a domain to which a function f belongs, and it can be known from function-domain correspondence information.

add_address(get_esp( ), get_ebp( ), RW, {d});

The function 25 delivers an instruction generated for each function and a position in which each instruction should be inserted (immediately after start of each function) to the memory protection instruction weaving function 28 as trouble propagation preventing information through stack area. The memory protection instruction weaving function 28 adds the instruction associated with each function immediately after start of each function in the source code on the basis of this trouble propagation preventing information (see [4] in FIG. 12).

Step [5]:

When the processing of the called function f is finished and a return to a calling source is made, an instruction which deletes access restriction on the stack area which has been utilized by the function from an access control table is added to the source program. Hereafter, further details will be described.

The Function 25 in the weaver 1 generates the following instruction to be inserted immediately before end of each function (immediately before a return statement) with respect to all functions in the program. Here, d is a domain to which a function f belongs, and it can be known from function-domain correspondence information. This instruction is equivalent to an instruction obtained by changing access restriction in the instruction in the step [4] to NO.

add_address(get_esp( ), get_ebp( ), NO, {d});

The Function 25 delivers an instruction generated for each function and a position in which each instruction should be inserted (immediately before the return statement) to the memory protection instruction weaving function 28 as trouble propagation preventing information through stack area. The memory protection instruction weaving function 28 adds an instruction associated with each function immediately before end of each function in the source code on the basis of this trouble propagation preventing information (see [5] in FIG. 12).

Step [6]:

An instruction which registers access restriction on a dynamically secured memory area in an access control table is added to the source program. Hereafter, further details will be described.

A function 24 for generating trouble propagation preventing information through dynamically secured memory area in the weaver 1 generates the following instructions to be inserted immediately before or after a dynamic memory securing instruction (for example, malloc) in the source program. Here, di, . . . , dj are domains which are higher in order than a domain d to which a function having a memory securing instruction described therein belongs, and dn, . . . , dm are domains which are lower in order than the domain d. These can be known from the function-domain correspondence information and the domain hierarchical information.

add_address2 (return value of malloc statement, argument (=size) of malloc statement, RW, {d, di, . . . , dj});

add_address2 (return value of malloc statement, argument (=size) of malloc statement, RO, {dn, . . . , dm});

The function 24 delivers these instructions and a position in which these instructions should be inserted (immediately before or after malloc) to the memory protection instruction weaving function 28 as trouble propagation preventing information through dynamically secured memory area. The memory protection instruction weaving function 28 adds the instructions immediately before or after malloc in the source code on the basis of this trouble propagation preventing information (see [6] in FIG. 12).

Step [7]:

When a dynamically secured memory area is released, an instruction which deletes access restriction on the memory area is added to the source program. Hereafter, further details will be described.

The function 24 in the weaver 1 generates the following instruction to be inserted immediately before or after an instruction (free) which releases the dynamically secured memory area in the source program. Here, d, di, . . . , dj, dn, . . . , dm represent the same domains as d, di, . . . , dj, dn, . . . , dm in the step [6].

add_address2 (argument of free statement, secured size, NO, {d, di, . . . , dj, dn, . . . , dm});

The function 24 delivers this instruction and a position in which this instruction should be inserted (immediately before or after free) to the memory protection instruction weaving function 28 as trouble propagation preventing information through dynamically secured memory area. The memory protection instruction weaving function 28 adds the instruction immediately before or after free in the source code on the basis of this trouble propagation preventing information (see [7] in FIG. 12).

Step [8]:

When calling a function, an instruction which registers access restriction on an argument area in an access control table is added to the source program so as to make it possible for the called function to refer to an area of an actual argument or an area of reference destination in the case where an actual argument is an address of reference destination. Hereafter, further details will be described.

An function 26 for generating argument laid-open information in the weaver 1 generates the following instruction for all arguments in each of all functions in the source program. (As a matter of fact, the following instructions should be executed only in the case where the calling function differs in domain from the called function.) Here, d is a domain of the function f, and i is an argument. If the argument i of the function f has a const decorator attached thereto, then the access restriction may not be RW, but may be RO.

add_address2 (&i, sizeof(i), RW, {d});

If the type of the argument i is “reference,” the following instruction is also generated in addition to the above-described instruction.

add_address2 (i, reference destination size of i in “argument information”, access restriction of reference destination of i in “argument information”, {d});

The function 26 delivers the instruction and a position in which the instruction should be inserted (immediately before a call statement in a function of a reading source or immediately after start of a function called) to the memory protection instruction weaving function 28 as argument laid-open information. The memory protection instruction weaving function 28 inserts the instruction into the source program on the basis of the argument laid-open information (see [8] in FIG. 12).

Step [9]:

When finishing the processing of the function, an instruction which causes an argument area laid open in the function to be unlaid-open in the access control table is added to the source program. Hereafter, further details will be described.

The function 26 in the weaver 1 generates the following instruction for all arguments in each of all functions in the source program immediately before end of the function (immediately before the return statement). Here, d is a domain to which the function f belongs, and i is an argument.

add_address2 (&i, sizeof(i), NO, {d});

If the type of the argument is “reference,” the following instruction is also generated in addition to the above-described instruction. add_address2 (i, reference destination size of i in “argument information”, NO, {d});

The function 26 delivers the instruction and a position in which the instruction should be inserted (immediately before the return statement) to the memory protection instruction weaving function 28 as argument laid-open information. The memory protection instruction weaving function 28 inserts the instruction into the source program on the basis of the argument laid-open information (see [9] in FIG. 12).

Step [10]:

If an execution domain is changed by function calling (i.e. if a domain of a function of a calling source is different from a domain of a function of a called function), then an instruction which changes an access control table referred to by the access controller 11 is added to the source program. Hereafter, further details will be described.

A function 27 for generating use access control table changeover information in the weaver 1 generates the following instruction to be added immediately after start of all functions in the program. Here, d is a domain of the function f.

dom_change(d);

The function 27 delivers this instruction and a position in which the instruction should be inserted (immediately after start of the function) to the memory protection instruction weaving function 28 as use access control table changeover information. The memory protection instruction weaving function 28 inserts the instruction into the source program on the basis of the use access control table changeover information (see [10] in FIG. 12).

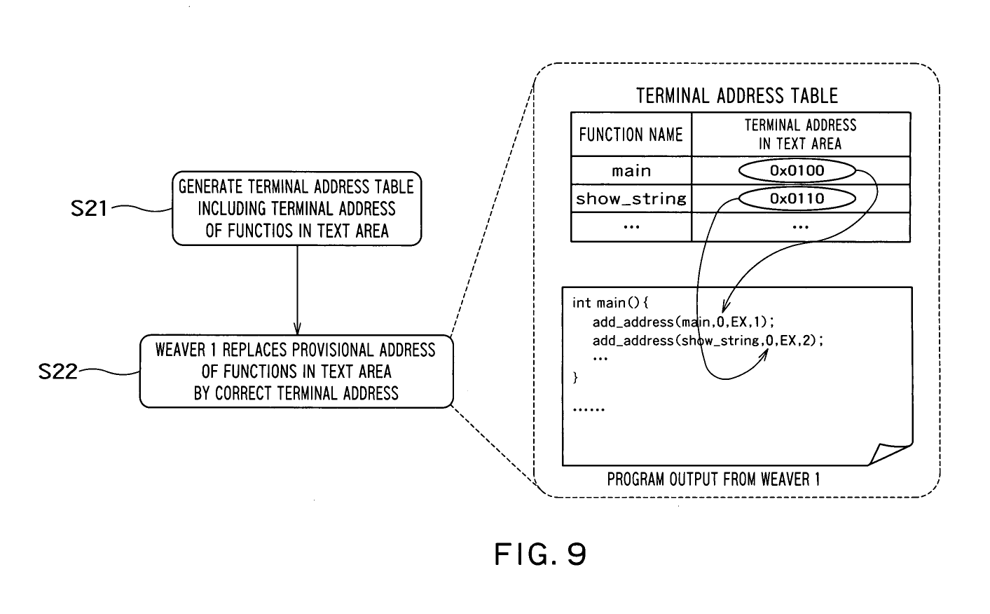

FIG. 9 is a diagram showing processing conducted by the compiler & linker 3 and the weaver 2 shown in FIG. 2.

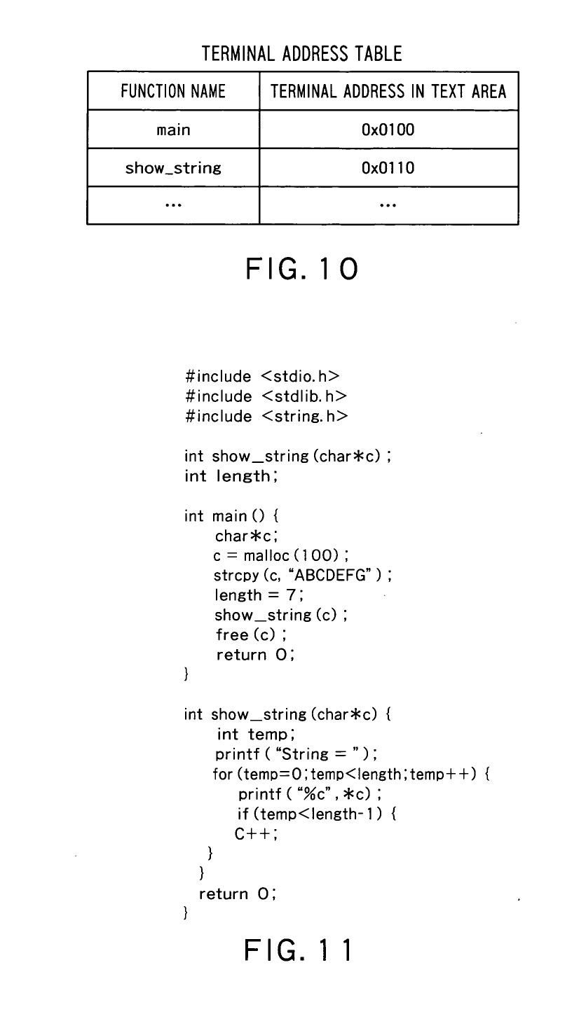

A program generated by the weaver 1 is input to the compiler & linker 3. The compiler & linker 3 obtains a terminal address of each function in the text area. The compiler & linker 3 outputs a table which associates functions with terminal addresses as a terminal address table (S21). An example of the terminal address table is shown in FIG. 10.

The weaver 2 replaces a provisional address contained in an operation instruction for the access control table generated in the step [3] by a correct terminal address on the basis of the terminal address table generated at the step S21 (S22). In this way, the source program having a memory protection function is generated.

Hereafter, an example of generation of a source program having a memory protection function from a source program shown in FIG. 11 will be described in order to cultivate a better understanding of the present embodiment.

The source program shown in FIG. 11 includes two simple functions, i.e., main and show_string. The show_string function is a function having a function of displaying a character string delivered as an argument. On the other hand, the main function is a function having a function of setting a character string.

Here, the character string display function (the function including only the show_string function) and the character string setting function (the function including only the main function) are cut and divided by domains to prevent a trouble, if any, in the show_string function from affecting the main function. For this purpose, the same memory protection policy as that shown in FIG. 6 is prepared.

If the source program shown in FIG. 11 and the memory protection policy shown in FIG. 6 are input to the weaver 1 shown in FIG. 2, the program shown in FIG. 12 is output from the weaver 1. In the program shown in FIG. 12, [1] to [10] written in comment lines correspond to [1] to [10] in the flow chart shown in FIG. 4.

If the program shown in FIG. 12 is input to the compiler & linker 3, the same terminal address table as that shown in FIG. 10 is output from the compiler & linker 3.

If the program shown in FIG. 12 and the terminal address table shown in FIG. 10 are input to the weaver 2, the source program having the memory protection function shown in FIG. 13 is output from the weaver 2. By conducting compile and link processing on this source program having the memory protection function, a program having a memory protection function which can be executed by the CPU 12 is generated.

According to the present embodiment, the software developer can acquire the program having memory protection by only describing a simple memory protection policy without rewriting the source program himself or herself, as heretofore described. Therefore, the burden on the software developer can be reduced. It is also useful to make debugging efficient. Furthermore, since a program having memory protection is generated utilizing information obtained by program analysis, it is possible to implement memory protection which is not too strict in access restriction. Furthermore, since a program having a memory protection function is automatically generated, it is possible to prevent the function quality of the program from falling.

What is claimed is:

1. A program generation method for generating a program to be executed in a system in which access from a CPU to a memory device is controlled based on an access control table describing access restriction for the memory device, comprising:
inputting a source program;
inputting a memory protection policy in which functions included in the source program are classified into either of a plurality of domains respectively, the access control table being assigned to each of the domains;
generating information which represents a relation between each global variable in the source program and domains utilizing the each global variable;
dividing domains utilizing the global variable into one or more high-order domains and one or more low-order domains;
adding to the source program an instruction which sets access restriction on the global variable to reading and writing permission in access control tables of the high-order domains; and
adding to the source program an instruction which sets access restriction on the global variable to reading permission in access control tables of the low-order domains.

2. The method according to claim 1, wherein the high-order domain is a highest-order domain and the lower-order domains are domains other than the highest-order domain.

3. The method according to claim 1, wherein if only one domain utilizes the global variable, the one domain is handled as the high-order domain.

4. The method according to claim 1, wherein the instruction which sets access restriction to reading and writing permission and the instruction which sets access restriction to reading permission are added to a function which is executed first in the source program.

5. The method according to claim 1, further comprising:
adding to a first function in the source program an instruction which sets access restriction on a memory area in a range from a stack pointer to a base pointer to reading and writing permission in an access control table of a domain to which the first function belongs in order to make it possible for the first function to access a stack area in a case where the first function is called by a second function; and
adding before a return instruction included in the first function an instruction which sets access restriction on the memory area to access inhibition in the access control table of the domain to which the first function belongs.

6. The method according to claim 1, further comprising:
adding to the source program a first instruction which sets access restriction on an argument of a third function to reading and writing permission or to reading permission in an access control table of a domain to which the third function belongs in order to make it possible for the third function to access the argument when the third function is called by a fourth function belonging to a domain different from that of the third function; and
adding to the source program a second instruction which sets access restriction on the argument to access inhibition in the access control table of the domain to which the third function belongs in order to prevent the argument from being accessed from the domain to which the third function belongs after an execution of the third function ends.

7. The method according to claim 6, wherein
the argument indicates a reference address,
the memory protection policy includes first information representing a memory address range from the reference address and second information representing access restriction to be set for the memory address range,
the adding the first instruction includes adding an instruction which sets access restriction on the memory address range from the reference address to access restriction represented by the second information, and
the adding the second instruction includes adding an instruction which sets access restriction on the memory address range from the reference address to access inhibition.

8. The method according to claim 7, wherein
the first instruction is added to the third function and
the second instruction is added after the first instruction in the third function and before a return instruction in the third function.

9. The method according to claim 7, wherein
the first instruction is added before a call instruction calling the third function in the fourth function, and
the second instruction is added after the call instruction in the fourth function.

10. The method according to claim 1, further comprising:
detecting from the source program a dynamic memory securing instruction and a memory release instruction;
adding to the source program an instruction which sets access restriction on a memory area secured by the dynamic memory securing instruction to reading and writing permission in access control tables of a domain to which the detected dynamic memory securing instruction belongs and a high-order domain of that domain;
adding to the source program an instruction which sets access restriction on the secured memory area to reading permission in an access control table of a low-order domain of that domain; and
adding to the source program an instruction which sets access restriction on the memory area released by the memory release instruction to access inhibition in the access control tables of that domain, the high-order domain, and the low-order domain.

11. The method according to claim 10, wherein
the instruction which sets access restriction to reading and writing permission and the instruction which sets access restriction to reading permission are added immediately before or immediately after the dynamic memory securing instruction, and
the instruction which sets access restriction to access inhibition is added immediately before or immediately after the memory release instruction.

12. The method according to claim 1, further comprising:
adding to the source program, instructions which set access restriction on memory areas in which functions in the program are located at a time of an execution of the program to executable in access control tables of domains to which the functions belong, in order to make it possible for the functions to access the memory areas.

13. The method according to claim 12,
further comprising calculating terminal addresses of the memory areas,
wherein the instructions to be added contain the terminal addresses of the memory areas respectively.

14. The method according to claim 12, wherein the instructions which sets access restriction to executable are added to a function which is executed first in the source program.

15. A program product for generating a program to be executed in a system in which access from a CPU to a memory device is controlled based on an access control table describing access restriction for the memory device, comprising modules for:
inputting a source program;
inputting a memory protection policy in which functions included in the source program are classified either of a plurality of domains respectively, the access control table being assigned to each of the domains;
generating information which represents a relation between each global variable in the source program and domains utilizing the each global variable;
dividing domains utilizing the global variable into one or more high-order domains and one or more low-order domains;
adding to the source program an instruction which sets access restriction on the global variable to reading and writing permission in access control tables of the high-order domains; and
adding to the source program an instruction which sets access restriction on the global variable to reading permission in access control tables of the low-order domains.

16. The program product according to claim 15, further comprising modules for:
adding to a first function in the source program an instruction which sets access restriction on a memory area in a range from a stack pointer to a base pointer to reading and writing permission in an access control table of a domain to which the first function belongs, in order to make it possible for the first function to access a stack area in a case where the first function is called by a second function; and
adding before a return instruction included in the first function an instruction which sets access restriction on the memory area to access inhibition in the access control table of the domain to which the first function belongs.

17. The program product according to claim 15, further comprising modules for:
adding to the source program a first instruction which sets access restriction on an argument of a third function to reading and writing permission or to reading permission in an access control table of a domain to which the third function belongs, in order to make it possible for the third function to access the argument when the third function is called by a fourth function belonging to a domain different from that of the third function; and
adding to the source program a second instruction which sets access restriction on the argument to access inhibition in the access control table of the domain to which the third function belongs, in order to prevent the argument from being accessed from the domain to which the third function belongs after an execution of the third function ends.

18. The program product according to claim 15, further comprising modules for:
detecting from the source program a dynamic memory securing instruction and a memory release instruction;
adding to the source program an instruction which sets access restriction on a memory area secured by the dynamic memory securing instruction to reading and writing permission in access control tables of a domain to which the detected dynamic memory securing instruction belongs and a high-order domain of that domain;
adding to the source program an instruction which sets access restriction on the secured memory area to reading permission in an access control table of a low-order domain of that domain; and
adding to the source program an instruction which sets access restriction on the memory area released by the memory release instruction to access inhibition in the access control tables of that domain, the high-order domain, and the low-order domain.

19. The program product according to claim 15, further comprising a module for
adding to the source program, instructions which set access restriction on memory areas in which functions in the program are located at a time of an execution of the program is executed to executable in access control tables of domains to which the functions belong, in order to make it possible for the functions to access the memory areas.
